(19) United States
(12) Patent Application Publication
(10) Pub. No.: US 2006/0071997 A1
(43) Pub. Date: Apr. 6, 2006

(54) Sheet handling device with sheet support plate and temperature control system

(75) Inventor: Pieter G.M. Kruijt, He Eindhoven (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/240,558

(22) Filed: Oct. 3, 2005

(30) Foreign Application Priority Data
Oct. 4, 2004 (EP) 04104859.6

(51) Int. Cl. B41J 2/01

(52) U.S. Cl. 347/104

(57) ABSTRACT

A sheet handling device including a sheet support plate having at least one internal fluid cavity; and a temperature control system containing a temperature controller and a closed circulating system for circulating a temperature control liquid through the cavity and through the temperature controller, the circulating system including expansion means for at least partially absorbing expansion and contraction of the liquid, the expansion means provided with at least one hose connecting the cavity and the temperature controller and adapted to flexibly expand and contract with the temperature control liquid.

### BACKGROUND OF THE INVENTION

The present invention relates to a sheet handling device comprising a sheet support plate having at least one internal fluid cavity; and a temperature control system containing a temperature controller and a closed circulating system for circulating a temperature control liquid through the cavity and through the temperature controller, the circulating system including expansion means for at least partially absorbing the expansion and contraction of the temperature control liquid.

In the copying and printing industry, a sheet handling device with a temperature controlled sheet support plate is frequently used for supporting an image receiving sheet and at the same time controlling the temperature thereof. For example, in a hot melt ink jet printer, a sheet, e. g. a sheet of paper, is advanced over a sheet support plate while the image is being printed. At room temperature, the hot melt ink is solid, and it is therefore necessary that the ink is heated in the printer above its melting point before it can be jetted onto the paper. The ink droplets that are jetted onto the paper tend to spread-out, more or less, before the ink solidifies. In order to obtain a suitable and constant amount of spreading of the ink droplets, the temperature of the sheet support plate and hence the temperature of the paper should be controlled such that the ink cools down at an appropriate rate.

In an initial phase of the print process, when a new sheet has been supplied, it is generally desirable to heat the sheet and to keep it at a suitable operating temperature. However, in the further course of the print process, it is necessary to dissipate the heat of the ink that solidifies on the paper. To that end, a temperature control fluid, e. g. a liquid, may be passed through the cavity in the plate in order to control the temperature of the plate.

For reasons of power consumption, it is required that the printer enters into a so-called sleep mode, when the printer is not operating for a certain length of time, and in the sleep mode, among others, the heating system for the sheet support plate is switched off. After a period of time, the temperature of the temperature control fluid and the sheet support plate will drop noticeably and may even reach room temperature. As a result, when a new image is to be printed, it will take a certain amount of time for the sheet support plate to be heated to its operating temperature.

Frequently, an incompressible liquid is used as the temperature control fluid. When the temperature control liquid is heated from room temperature to the operating temperature, it will expand, although it will remain in the liquid state. When the temperature falls again, the liquid will contract. Therefore, in order to avoid the build-up of a high pressure due to a temperature rise of the temperature control liquid, an expansion tank has been provided for absorbing the expansion and/or contraction of the liquid. However, such an expansion tank increases the amount of material that has to be heated when a new image is to be printed after a period of inactivity.

### SUMMARY OF THE INVENTION

Accordingly, it is an object of the present invention to provide a sheet handling device which allows to quickly bring the sheet support plate to its operating temperature, and to provide a printer containing such a sheet handling device.

According to the present invention, this object is achieved by a sheet handling device of the type indicated above, wherein that the expansion means includes at least one hose for connecting the cavity and the temperature controller which is adapted to flexibly expand and contract.

Because the expansion means consists of one or more hoses that are also used to connect the cavity and the temperature controller, the number of structural elements is reduced. This is advantageous, because it involves a reduction of the heat capacity of the temperature control system. Thus, the time that is needed to heat the sheet support plate from room temperature to its operating temperature is reduced, with a corresponding savings in energy. The present invention is also advantageous in that production costs are reduced. Furthermore, when a rigid metal tube is replaced by a flexible hose made of, e.g., an elastomeric polymer, the heat capacity of the temperature control system is further reduced.

For example, the length, diameter, material, and wall thickness of the hose are adapted to enable the hose to flexibly expand and contract. The larger the length of the hose is, the larger is the increase in volume that is produced by a certain expansion of the hose wall. Also, the larger the diameter of the hose, the larger is the increase in volume for a certain amount of expansion of the wall of the hose, because the increase of the cross section of the hose is proportional to its diameter. The expansion of the hose can also be increased by choosing a suitable material and by reducing the wall thickness of the hose. At the same time, the chosen material has to be compatible with the temperature control liquid.

Preferably, the hose is adapted to flexibly expand and contract in accordance with the volume changes that correspond to the expected temperature changes of the liquid, e. g., between room temperature and the operating temperature of the sheet support plate.

The present invention is particularly useful for a hot-melt ink jet printer.

### BRIEF DESCRIPTION OF THE DRAWINGS

A preferred embodiment of the invention will now be described in conjunction with the drawings, in which:

FIG. 1 is the schematic perspective view of a hot melt ink jet printer; and

FIG. 2 is a partial top view of a sheet support plate in the printer shown in FIG. 1.

### DETAILED DESCRIPTION OF THE INVENTION

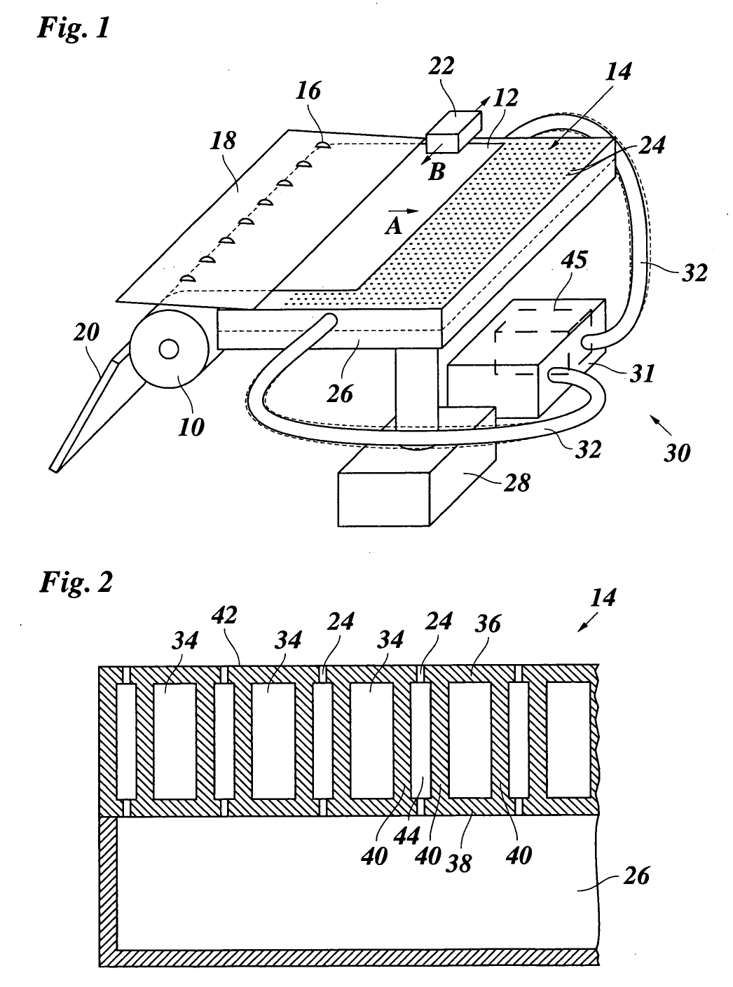

As is shown in FIG. 1, a hot melt ink jet printer includes a platen 10 which is intermittently driven to rotate in order to advance a sheet 12, e. g. a sheet of paper, in a direction indicated by an arrow A over the top surface of a sheet support plate 14. A plurality of transport rollers 16 are rotatably supported in a cover plate 18 and form a transport nip with the platen 10, so that the sheet 12, which is supplied from a reel (not shown) via a guide plate 20, is paid out through a gap formed between an edge of the cover plate 18 and the surface of the sheet support plate 14.

A carriage 22 which includes a number of ink jet printheads (not shown) is mounted above the sheet support plate 14 so as to reciprocate in the direction of arrows B across the sheet 12. In each pass of the carriage 22, a number of pixel lines are printed on the sheet 12 by means of the printheads which eject droplets of hot melt ink onto the sheet in accordance with image information supplied to the printheads. For the sake of simplicity, guide and drive means for the carriage 22, ink supply lines and data supply lines for the printheads, and the like, have not been shown in the drawing.

The top surface of the sheet support plate 14 has a regular pattern of suction holes 24 which pass through the plate and open into a suction chamber 26 that is formed in the lower part of the plate 14. The suction chamber is connected to a blower 28 which creates a subatmospheric pressure in the suction chamber, so that air is drawn-in through the suction holes 24. As a result, the sheet 12 is pulled against the flat surface of the support plate 14 and is thereby held in a flat condition, especially in the area which is scanned by the carriage 22, so that a uniform distance between the nozzles of the printheads and the surface of the sheet 12 is established over the entire width of the sheet and thus a high print quality can be achieved.

The droplets of molten ink that are jetted out from the nozzles of the printheads have a temperature of 100° C. or more and cool down and solidify after they have been deposited on the sheet 12. Thus, while the image is being printed, the heat of the ink must be dissipated at a sufficient rate. On the other hand, in the initial phase of the image forming process, the temperature of the sheet 12 should not be too low because if otherwise, the ink droplets on the sheet 12 would be cooled too rapidly and would not have sufficient time to spread-out. For this reason, the temperature of the sheet 12 is controlled via the sheet support plate 14 by means of a temperature control system 30. The temperature control system includes a temperature controller 31 and a circulating system with hoses 32 that are connected to opposite ends of the plate 14.

As shown in FIG. 2, a plurality of elongated cavities 34 are formed in the interior of the sheet support plate 14, so as to extend in parallel with one another and in parallel with the direction (B) of travel of the carriage 22 between opposite ends of the plate 14, where the cavities are connected to the hoses 32 through suitable manifolds. Each cavity 34 is delimited by a top wall 36, a bottom wall 38 and two separating walls 40 and is thereby separated from the suction holes 24 and the suction chamber 26. The top walls 36, together, define the top surface 42 of the plate 14 which is machined to be perfectly flat. Between each pair of two separating walls 40, which delimit to adjacent cavities 34, a hollow space 44 is formed, through which the suction holes 24 pass through into the suction chamber 26.

It will be understood that the temperature controller 31 may include a heater, a temperature sensor, a heat sink and the like for controlling the temperature of the liquid, as well as a pump 45 or other displacement means for circulating the liquid through the cavities 34 of the sheet support plate 14.

The material of hoses 32 and their wall thickness are adapted to enable the hose to flexibly expand and contract in response to expansion and contraction of the temperature control liquid. The material of hoses 32 may be, for example, an elastomeric polymer. In FIG. 1, expanded hoses 32 are schematically indicated by dashed lines.

While minimum values for the length and the diameter of hoses 32 are imposed by the dimension of the sheet support plate 14 and the required flow rate of the liquid, the length and diameter of the hoses may be selected somewhat larger in order to cope with the expected temperature and volume changes of the liquid. For example, the temperature changes of the liquid may be in the order of magnitude of the temperature change of the sheet support plate 14 between room temperature T₁ and an operating temperature T₂, which is for example in the range of 30° C. to 40° C. The optimal length and diameter of the hoses 32 depend on the ability of the hose wall material to expand, and also depend on the volume of cavities 34 and the volume of temperature control liquid contained in the temperature controller 31. The larger the length and the diameter of the hoses 32, the larger will be the increase in volume obtained by expansion of the hoses 32. At the same time, the volume ratio of hoses 32 as compared to the overall volume of temperature control liquid that is contained in the system will also increase. However, the smaller the overall volume, the smaller is the heat capacity of the liquid. Thus, it is possible to determine an optimal length and diameter of the hoses, for example, by experiment, so that the expansion of the liquid is at least partially absorbed by the expansion of the hoses, while at the same time the heat capacity of the temperature control system is maintained at an economic level.

The wall thickness of the hoses 32 may be optimized in order to ensure, on the one hand, a sufficient stability of the hoses and a sufficiently small diffusion rate of the liquid and, on the other hand a sufficient elasticity, so that the elastic restoring forces of the expanded hoses will only lead to a minor increase in the pressure of the liquid. At any rate, the pressure increase in the cavities 34 should be small enough to avoid a deformation of plate 14. Of course, fittings (not shown) for connecting the hoses 32 to the pressure controller 31 and to the cavities 34 are pressure-tight to ensure that liquid does not leak from the circulating system due to the pressure that remains when the hoses 32 expand.

Thanks to the expandability of the hoses 32, a dedicated expansion tank for absorbing the expansion or contraction of the liquid can be dispensed with. As a result, the temperature control system can be assembled from a low number of parts in the production process, thereby decreasing production costs. Due to the low number of parts and the flexibility of the hoses 32, equipment maintenance is also facilitated.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A sheet handling device comprising a sheet support plate containing at least one internal fluid cavity and a temperature control system having a temperature controller and a closed circulating system for circulating a temperature control liquid through said cavity and through said temperature controller, the circulating system containing expansion means for at least partially absorbing the expansion and contraction of the liquid, wherein the expansion means includes at least one hose for connecting the cavity with the temperature controller and adapted to flexibly expand and contract.

2. The sheet handling device of claim 1, wherein the temperature controller is adapted to maintain the sheet support plate 14 at an operating temperature T₂ which is different from room temperature T₁, and the hose is adapted to flexibly expand and contract in an amount corresponding to a volume change of the temperature control liquid caused by a temperature change between T₂ and T₁.

3. A printer containing the sheet handling device according to claim 1.

4. The printer of claim 3, said printer being a hot-melt ink jet printer.
